(19) United States
(12) Patent Application Publication
(10) Pub. No.: US 2002/0095682 A1
(43) Pub. Date: Jul. 18, 2002

(54) Method and system for distributing an event

(76) Inventor: Michael Ledbetter, (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 09/782,813

(22) Filed: Feb. 14, 2001

Related U.S. Application Data
(60) Provisional application No. 60/182,162, filed on Feb. 14, 2000.

(51) Int. Cl. H04N 7/173

(52) U.S. Cl. 725/87

(57) ABSTRACT

A method of distributing an event to a viewer including capturing the event on a capturing device as a broadcast transmission that has at least a 1,000 pixel by 1,000 pixel resolution, then transmitting the broadcast transmission to a distributing device and then distributing the broadcast transmission from the distributing device to the viewer over a standard twisted pair wire at the at least 1000 pixel by 1000 pixel resolution.

### CROSS REFERENCE TO RELATED APPLICATION

This application claims the benefit of U.S. Provisional Application 60/182,162 filed on Feb. 14, 2000, the disclosure of which is herein incorporated by reference.

### BACKGROUND OF THE INVENTION

1. Field of the Invention

The present invention relates generally to the transmission of broadcast quality events to a viewer and listener, and more particularly, to a method and system of distributing broadcast quality events to those viewers and listeners over a standard twisted pair copper wire.

2. Description of the Related Art

The current state of broadcast quality video and audio through both data networks and standard televisions is problematic. The main reason for this problem is a problem known in the industry as the “last mile” problem. This “last mile” problem is explained with reference to prior art FIG. 1.

Prior art FIG. 1 is a block diagram view of the current state of delivering broadcast quality content (for example, movies, news, sports, sitcoms, etc.) and stereophonic audio to an audience. In FIG. 1, captured content 5 is being sent to an audience 10 through the transmitter 15 and receiver 20. The captured content 5 can be any content such as movies, news, sports, commercials that is captured by a camera, audio receiver or the like. The captured content 5 is transmitted through a twisted pair 25 to the transmitter 15. The twisted pair 25 is a standard category 5 copper wire that is used in the paradigm of prior art FIG. 1. Cables can also be used to transmit the captured content 5 to the transmitter 15, as well as media twist copper lines. Generally, the twisted pair 25 is needed since the content is captured using a camera and the broadcast quality signal needs to be transmitted to audiences at their home. It is therefore imperative that the captured content 5 and quality of that captured content 5 remain at a broadcast quality level of appearance.

The broadcast quality level is typically determined by the pixel resolution of the image being viewed. Broadcast quality is known throughout the industry as a quality of at least 1,000 pixel by 1,000 pixels resolution. This is higher than the standard quality that audiences are used to viewing a captured content on a television (700 pixels by 800 pixels resolution). The general distance between the captured content 5 to the transmitter 15 is normally a few miles, such as the distance from an athletic stadium to a van or truck outside that will transmit the captured event inside the athletic stadium. The event is then transmitted from the transmitter 15 to the receiver 20. The transmitter 15 is generally a satellite held on a satellite truck outside of a athletic stadium, for example, using the previous example, and the receiver 20 is generally a cable distributor that receives the satellite signal of the captured content at the cable station. From the receiver, the captured content is sent to the audience 10 through a cable 30. Herein lies the problem addressed by the present invention. The distance from the receiver to the audience is typically known as the “last mile” problem discussed above. That is, in the past, the captured content arriving at the receiver 20 maintained the broadcast quality level of resolution of approximately 1,000 pixel by 1,000 pixels. However, to maintain that resolution to the audience 10, a cable line was needed or other means that maintained the quality of the captured content. Alternatives to the cable means was another satellite transmitter at the receiver 20 with a satellite receiver at the audience 10. Unfortunately, several problems exist with the cable 30 and satellite (not shown) alternatives to sending the captured content across the last mile 35.

A first problem is that cable lines are expensive to route from the receiver 20 to the audience 10. Likewise, satellite distribution of the captured content between the receiver 20 to the audience 10 requires equipment set up at the receiver 20 and audience 10 and costs are prohibitably high.

A further problem is that, in addition to broadcast quality content to a television, that same broadcast quality also needs to be sent to a computer, television or receiver through a data network. That is, the captured content 5 also may go through the cable 30 or satellite as long as sufficient broadband space is available on the cable or the satellite. In addition to cable and satellite for data information, telephone companies are providing digital subscriber lines to the broadband signals to the audience 10 from the receiver 20. However, few consumers have taken advantage of the broadband advantages of DSL, cable modems and satellites because the quality of the captured content arriving on either the computer or television is not broadcast quality content. Thus, consumers who want broadband links have two choices: cable television companies which are about ⅔ of the way done with revamping the systems so that they can connect customers to the internet; and phone companies which are adding electronics to their switching centers to let them offer a high-speed service called digital subscriber lines. Satellite link ups are also becoming available but are trailing way behind.

Few people are taking advantage of this broadband capacity because customers are looking for an application that makes the broadband world touchable and believable to them, that shows its benefit. At present, the quality of the video content being sent over the internet has a poor resolution so consumers are not interested in purchasing the broadband services.

In essence, a severe problem exists in the industry in that the “last mile” 35 needs to be able to provide the captured content from the receiver 20 to the audience 10 at a broadcast quality level in order for consumers to watch the captured content on computers and televisions.

A need therefore exists for a manner of sending a broadcast quality content from the receiver 20 to the audience at a low cost to consumers and the industry as a whole. One method that would truly lower costs to all the telecommunications industry would be to provide the captured content 5 through a standard category 5 twisted pair copper wire that exists in virtually every office and home having a telephone. If it was possible to send a broadcast quality captured content from the receiver 20 through a category 5 copper wire to the audience 10 and maintain the broadcast quality of the signal, low infrastructure costs and easy application could be performed by the telecommunications industry. However, under current conventional systems, a category 5 twisted pair copper wire is not capable of maintaining the broadcast quality from the receiver 20 to the audience 10 at the last mile.

One product known as the A/V Twister® sold by Prime Image, Inc. of San Jose, Calif. has attempted to solve a problem of sending a broadcast quality captured content 5 between the captured content 5 and a transmitter 15 through a category 5 copper wire 25. The A/V Twister® is a modulator/demodulator system 40 that is placed between the captured content 5 and a transmitter 15 in order to maintain the broadcast quality along the copper wire 25 between the captured content 5 and the transmitter 15. Typically, the modulator/demodulator system 40 is capable of maintaining a broadcast quality content for up to one mile on a standard category 5 copper wire or up to two miles on a media twist wire. As mentioned above, this modulator/demodulator system has only been used between the captured content 5 and the transmitter 15 but never between the receiver 20 and the audience 10.

A need therefore exists for a method of distributing the captured content between a receiver and an audience using a standard category 5 twisted pair wire.

### SUMMARY OF THE INVENTION

The present invention provides for a method of distributing an event to a viewer by capturing the event on a capturing device as a broadcast transmission. The broadcast transmission has at least a 1000 pixel by 1000 pixel resolution. The broadcast transmission is then transmitted to a distributing device where the broadcast transmission is distributed from the distributing device to a viewer over standard twisted pair wire at the 1000 pixel by 1000 pixel resolution.

The invention, in a further embodiment, provides for a method of distributing an event to a viewer by capturing the event on a capturing device as a broadcast transmission where the broadcast transmission has at least a frequency of 4.5 megahertz. The broadcast transmission is then transmitted to a distributing device and then the distributing device distributes the broadcast transmission to the viewer over standard twisted pair wire at at least a frequency of 4.5 megahertz.

In a still further embodiment, the present invention provides for a method of distributing a stereophonic event to a listener by capturing the stereophonic event on a capturing device into a stereophonic transmission, transmitting the stereophonic transmission to a distributing device and distributing the stereophonic transmission from the distributing device to the listener over a standard twisted pair wire.

In an even further embodiment, the present invention provides for a method of distributing a stereophonic and visual event to a viewer by capturing both the stereophonic and visual event on a capturing device into a stereophonic and broadcast transmission, where the stereophonic and broadcast transmission have at least a 1000 pixel by 1000 pixel resolution. Then the stereophonic and broadcast transmission is transmitted to a distributing device where both the stereophonic and broadcast transmission are distributed from the distributing device to the viewer over a standard twisted pair wire at the at least 1000 by 1000 pixel resolution.

In another embodiment, the present invention provides for a system for distributing an event to a viewer that includes a capturing device for capturing the event as a broadcast transmission where the broadcast transmission has at least a 1000 pixel by 1000 pixel resolution, a transmitting device for transmitting the broadcast transmission to a distributing device and a modulator/demodulator device between the distributing device and the viewer for distributing the broadcast transmission from the distributing device to the viewer over standard twisted pair wire at at least a 1000 pixel by 1000 pixel resolution.

The present invention further provides, in another embodiment, for a system for distributing an event to a viewer that includes a capturing device for capturing the event as a broadcast transmission where the broadcast transmission has at least a frequency of 4.5 megahertz, a transmitting device for transmitting the broadcast transmission to a distributing device, and a modulator/demodulator device between the distributing device and the viewer for distributing the broadcast transmission from the distributing device to the viewer over a standard twisted pair wire at a frequency of at least 4.5 megahertz.

In a further embodiment, the present invention provides for a system for distributing a stereophonic event to a listener including a capturing device for capturing the stereophonic event as a stereophonic transmission, a transmitting device for transmitting the stereophonic transmission to a distributing device and a modulator/demodulator device between the distributing device and the listener for distributing the stereophonic transmission from the distributing device to the listener over a standard twisted pair wire.

### BRIEF DESCRIPTION OF THE DRAWINGS

A more complete appreciation of the invention and many of the advantages thereof will be readily obtained as the same becomes better understood by reference of the detailed description when considered in connection with the accompanying drawings, wherein:

Prior art FIG. 1 is a block diagram view of a conventional system for delivering broadcast quality content; and

FIG. 2 is a block diagram view of an embodiment of the system of the present invention.

### DETAILED DESCRIPTION OF THE PREFERRED EMBODIMENT

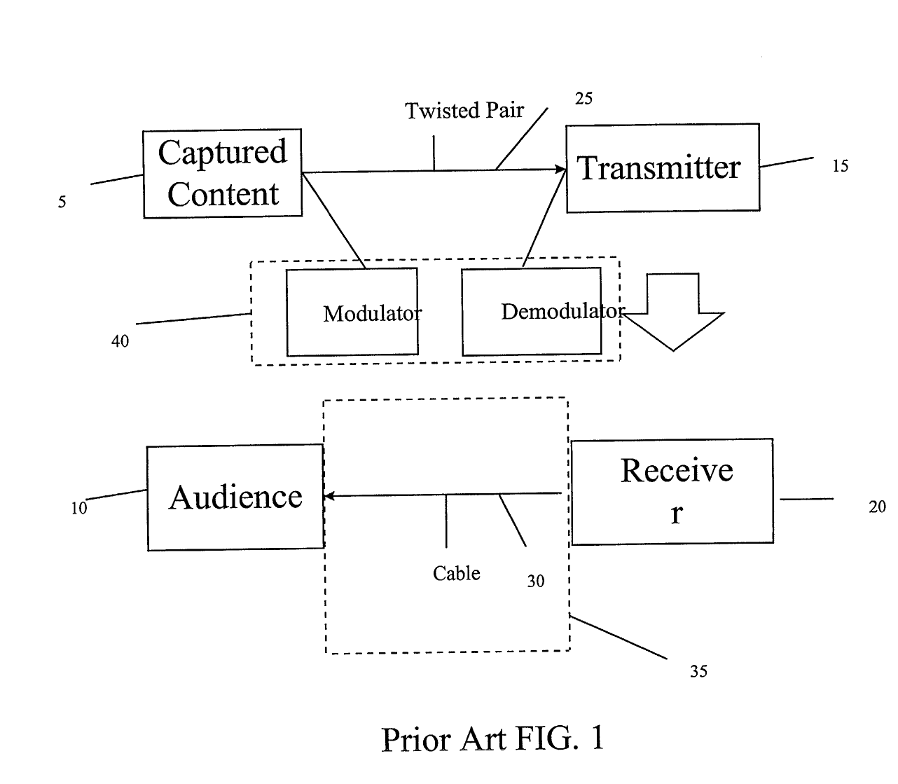

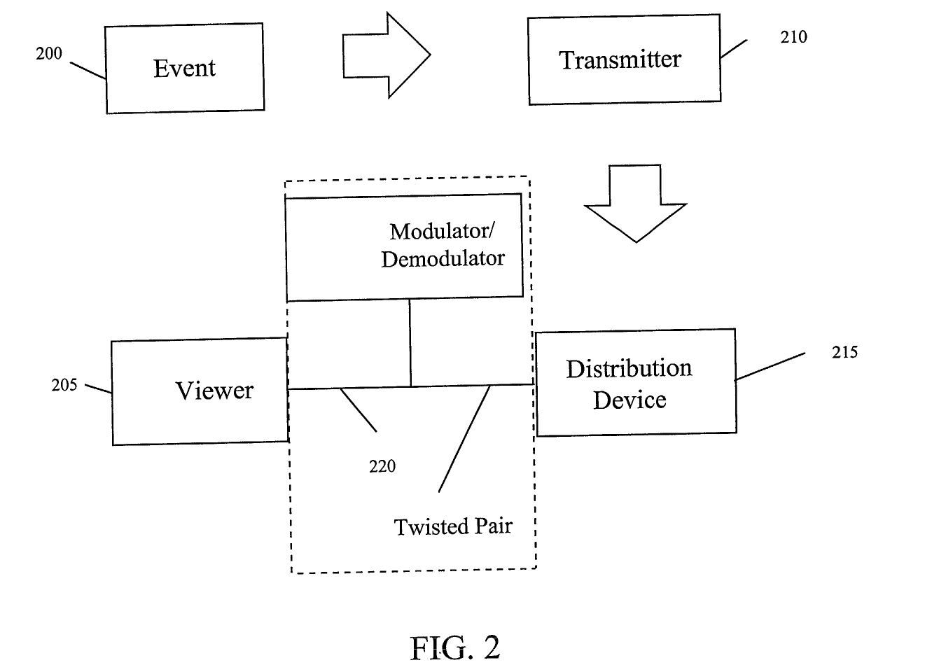

The present invention has a tremendous application to solve the problems related in the prior art relating to the “last mile” problem. Those benefits are apparent from FIG. 2 which is a block diagram view of an embodiment of the system of the present invention. In FIG. 2, an event 200 is to be transmitted to a viewer 205. The event may be any type of television content, for example, movies, news, sports, advertisements, or any other type of content that may be viewed by a viewer. The event may further be an audio event that may be listened to by a listener. Thus, the viewer 205, may be a listener (not shown) in a further embodiment of the present invention. Again, it is noted that the event, and content contained therein, be transmitted to the viewer as shown in FIG. 2. For example, in one embodiment, the event may be an athletic event, such as a football game, that is going to be transmitted to a viewer 205, to be viewed on a television (not shown) or computer monitor. The event is captured at 200, typically by broadcast quality camera, but may also be captured by any type of capturing device such as a recording device or other visual or audio recording means. The broadcast quality camera that captures the event 200 typically captures the event at a resolution of at least 1000 pixel by 1000 pixel. That is, as is well known in the broadcast art, the quality of the content being captured is broadcast quality, or of a resolution that is at least 1000 pixel by 1000 pixel as is well known in the art.

The event is typically conveyed to a transmitter 210 for further distribution. It is noted that the event is captured as a broadcast transmission, prior to sending the broadcast transmission to the transmitter 210. However, it is not necessary that the captured event be captured as a broadcast transmission at that point but only necessary that the event be somehow transmitted to the transmitter 210. After the event is transmitted to the transmitter 210, the transmitter transmits the broadcast transmission to a distributing device 215. It is noted that the captured event will broadcast transmission that is sent from the event 200 to the transmitter 210 and from the transmitter 210 to the distribution device 215 may be transmitted through various means. These means include transmitting the broadcast transmission over, for example, a satellite transmitter at the transmitter 210 that is received at the distribution device by satellite receiver. Other possible methods include transmitting the broadcast transmission over a cable line and receiving the broadcast transmission by a television receiver as the distribution device. Still further means includes transmitting the broadcast transmission over a media twist line and receiving the broadcast transmission by television receiver at the distribution device 215. By media twist, it is understood that this type of line is well known in the art and is manufactured by a company known as Belcore. Once the broadcast transmission arrives at the distribution device 215, the distribution device may then send the broadcast transmission to the viewer 205 through a standard twisted pair wire 220. Here is the true benefit of the present invention. By using a standard twisted pair wire 220, in conjunction with a modulator/demodulator 225, the broadcast transmission maintains it 1000 pixel by 1000 pixel resolution when it arrives at the viewer 205. In the past, a cable wire or satellite needed to be used in order to maintain that 1000 pixel by 1000 pixel resolution. This was expensive and burdensome to provide since cable lines needed to be connected to all viewers 205. However, twisted pair standard wire 220 is commonly used throughout all present locations such as homes and offices, as a standard telephone twisted pair wire. Thus, it is possible to easily use that infrastructure already set up in conjunction with the modulator/demodulator 225 to maintain the quality of the transmission for a distance of up to one mile using the standard twisted pair wire 220. Never before has a standard twisted pair wire 220 been capable of maintaining the 1000 pixel by 1000 pixel resolution at these distances. It is here that the true benefit of the invention is provided.

It is noted that the same benefits provided to a viewer 205 to receive at least a 1000 pixel by 1000 pixel resolution image is also available for stereophonic audio which was never before capable of being transmitted over a standard twisted pair wire in the past. Likewise, the combination of both the stereophonic transmission and the broadcast transmission simultaneously across the twisted pair wire 220 has also never been achieved. Thus, tremendous advantages and cost savings are achieved by using the modulator/demodulator 225 in conjunction with the standard twisted pair wire 220 to distribute both visual and stereophonic audio to a viewer and listener, respectively. It is noted that the modulator/demodulator may be a standard A/V Twister® that is manufactured by Prime Image, Inc. of San Jose, Calif., as described in the publication “A/V Twister, Twisted Pair Wire Carries the Load of Cable,” and printed in September 1998 by Prime Image, Inc. hereby incorporated by reference.

The method an system of the present invention has an endless number of applications. For example, any local area network utilizing personal computers may be connected over a standard twisted pair wire to deliver high resolution (1000 pixel by 1000 pixel) broadcast transmission to each work station. Again, as long as the modulator/demodulator is placed between the distribution device and the viewer, such standard copper twisted pair wire may be utilized. Another application would include networks for municipalities of a territory to communicate, on a scheduled basis, or in an emergency situation across live video feeds at the current 1000 pixel by 1000 pixel broadcast quality transmission. In this application, the event would be a recorded or captured event from a mayor's office, Chamber of Commerce, police department, or fire department which would be distributed, for example, through microwave or satellite communication to other municipality offices and distributed from that distribution device, such as the satellite, down to individual televisions or computer screens utilizing the twisted pair wires at a 1000 pixel by 1000 pixel resolution.

Still another application includes events in hotels, entertainment facilities or the like that could be transmitted between hotels at the 1000 by 1000 pixel resolution. Again, the applications are endless depending on the event which is to be transmitted to a viewer at the broadcast quality.

What is claimed is:

1. A method of distributing an event to a viewer, comprising:
capturing said event on a capturing device as a broadcast transmission;
transmitting said broadcast transmission to a distributing device; and
distributing said broadcast transmission from said distributing device to said viewer over a standard twisted pair wire.

2. The method of claim 1, wherein said capturing step further comprises the step of capturing said event on a broadcast quality camera transmission, said broadcast transmission having at least a 1,000 pixel by 1,000 pixel resolution.

3. The method of claim 1, wherein said capturing step further comprises having said broadcast transmission with greater than a 1,000 pixel by 1,000 pixel resolution.

4. The method of claim 1, wherein said capturing step further comprises having said broadcast transmission with a 1,000 pixel by 1,000 pixel resolution.

5. The method of claim 1, wherein said transmitting step further comprises the steps of:
transmitting said broadcast transmission over a satellite transmitter; and
receiving said broadcast transmission by a satellite receiver.

6. The method of claim 1, wherein said transmitting step further comprises the steps of:
transmitting said broadcast transmission over a cable line; and
receiving said broadcast transmission by a television receiver.

7. The method of claim 1, wherein said transmitting step further comprises the steps of:
transmitting said broadcast transmission over a media twist line; and
receiving said broadcast transmission by a television receiver.

8. The method of claim 1, wherein said distributing step further comprises the step of distributing said broadcast transmission from said distributing device to said viewer over a copper wire.

9. The method of claim 8, wherein said distributing step further comprises the step of distributing said broadcast transmission from said distributing device to said viewer over a category five wire.

10. The method of claim 1, wherein said distributing step further comprises the step of distributing said broadcast transmission from said distributing device to said viewer over a media twist line.

11. The method of claim 10, wherein said distributing step further comprises the step of:
distributing said broadcast transmission from said distributing device to said viewer over said media twist for a distance of up to two miles at at least a 1,000 pixel by 1,000 pixel resolution.

12. The method of claim 1, wherein said distributing step further comprises the step of:
distributing said broadcast transmission from said distributing device to said viewer over a standard twisted pair wire at a resolution of 1,000 pixel by 1,000 pixel.

13. The method of claim 1, wherein said distributing step further comprises the step of:
distributing said broadcast transmission from said distributing device to said viewer over a standard twisted pair wire at a resolution greater than 1,000 pixel by 1,000 pixel.

14. The method of claim 1, wherein said distributing step further comprises the step of:
distributing said broadcast transmission from said distributing device to said viewer over said standard twisted pair wire for a distance of up to one mile at said at a resolution of at least 1,000 pixel by 1,000 pixel.

15. A method of distributing an event to a viewer, comprising:
capturing said event on a capturing device as a broadcast transmission, said broadcast transmission having at least a frequency of 4.5 megahertz;
transmitting said broadcast transmission to a distributing device; and
distributing said broadcast transmission from said distributing device to said viewer over a standard twisted pair wire at said at least a frequency of 4.5 megahertz.

16. The method of claim 15, wherein said capturing device is a broadcast quality camera.

17. The method of claim 15, wherein said capturing step further comprises having said broadcast transmission with greater than a 4.5 megahertz frequency.

18. The method of claim 15, wherein said capturing device has a frequency of 4.5 megahertz.

19. The method of claim 15, wherein said transmitting step further comprises the steps of:
transmitting said broadcast transmission over a satellite transmitter; and
receiving said broadcast transmission by a satellite receiver.

20. The method of claim 15, wherein said transmitting step further comprises the steps of:
transmitting said broadcast transmission over a cable line; and
receiving said broadcast transmission by a television receiver.

21. The method of claim 15, wherein said transmitting step further comprises the steps of:
transmitting said broadcast transmission over a media twist line; and
receiving said broadcast transmission by a television receiver.

22. The method of claim 15, wherein said distributing step further comprises the step of distributing said broadcast transmission from said distributing device to said viewer over a wire.

23. The method of claim 22, wherein said distributing step further comprises the step of distributing said broadcast transmission from said distributing device to said viewer over a category five wire.

24. The method of claim 15, wherein said distributing step further comprises the step of distributing said broadcast transmission from said distributing device to said viewer over a media twist line.

25. The method of claim 15, wherein said distributing step further comprises the step of:
distributing said broadcast transmission from said distributing device to said viewer over a standard twisted pair wire at a frequency of 4.5 megahertz.

26. The method of claim 15, wherein said distributing step further comprises the step of:
distributing said broadcast transmission from said distributing device to said viewer over a standard twisted pair wire at greater than a frequency of 4.5 megahertz.

27. The method of claim 15, wherein said distributing step further comprises the step of:
distributing said broadcast transmission from said distributing device to said viewer over said standard twisted pair wire for a distance of up to one mile at said at least a frequency of 4.5 megahertz.

28. The method of claim 10, wherein said distributing step further comprises the step of:
distributing said broadcast transmission from said distributing device to said viewer over said media twist for a distance of up to two miles at said at least a frequency of 4.5 megahertz.

29. A method of distributing a stereophonic event to a listener, comprising:
capturing said stereophonic event on a capturing device into a stereophonic transmission; transmitting said stereophonic transmission to a distributing device;
distributing said stereophonic transmission from said distributing device to said listener over a standard twisted pair wire.

30. The method of claim 29, wherein said capturing step further comprises the step of capturing said stereophonic event on a broadcast quality camera.

31. The method of claim 29, wherein said transmitting step further comprises the steps of:
transmitting said stereophonic transmission over a satellite transmitter; and
receiving said stereophonic transmission by a satellite receiver.

32. The method of claim 29, wherein said transmitting step further comprises the steps of:
transmitting said stereophonic transmission over a cable line; and
receiving said stereophonic transmission by a television receiver.

33. The method of claim 29, wherein said transmitting step further comprises the steps of:
transmitting said stereophonic transmission over a media twist line; and
receiving said stereophonic transmission by a stereophonic receiver.

34. The method of claim 29, wherein said distributing step further comprises the step of distributing said stereophonic transmission from said distributing device to said listener over a wire.

35. The method of claim 34, wherein said distributing step further comprises the step of distributing said broadcast transmission from said distributing device to said listener over a category five wire.

36. The method of claim 29, wherein said distributing step further comprises the step of distributing said stereophonic transmission from said distributing device to said listener over a media twist line.

37. The method of claim 36, wherein said distributing step further comprises the step of:
distributing said stereophonic transmission from said distributing device to said listener over said media twist for a distance of up to two miles.

38. The method of claim 29, wherein said distributing step further comprises the step of:
distributing said stereophonic transmission from said distributing device to said listener over said standard twisted pair wire for a distance of up to one mile.

39. A method of distributing a stereophonic and visual event to a viewer, comprising:
capturing said stereophonic and visual event on a capturing device into a stereophonic and broadcast transmission, said stereophonic and broadcast transmission having at least a 1,000 pixel by 1,000 pixel resolution;
transmitting said stereophonic and broadcast transmission to a distributing device;
simultaneously distributing said stereophonic transmission from said distributing device to said listener over a standard twisted pair wire at said at least 1,000 pixel by 1,000 pixel resolution.

40. A system for distributing an event to a viewer, comprising:
a capturing device for capturing said event as a broadcast transmission, said broadcast transmission having at least a 1,000 pixel by 1,000 pixel resolution;
a transmitting device for transmitting said broadcast transmission to a distributing device; and
a modulator/demodulator device between said distributing device and said viewer for distributing said broadcast transmission from said distributing device to said viewer over a standard twisted pair wire at said at least 1,000 pixel by 1,000 pixel resolution.

41. The system of claim 40, Wherein said capturing device is a broadcast quality camera.

42. The system of claim 40, wherein said broadcast transmission has greater than a 1,000 pixel by 1,000 pixel resolution.

43. The system of claim 40, wherein said broadcast transmission has a 1,000 pixel by 1,000 pixel resolution.

44. The system of claim 40, wherein said transmitting device is a satellite transmitter.

45. The system of claim 44, wherein said distributing device is a satellite receiver.

46. The system of claim 40, wherein said transmitting device is a cable line.

47. The system of claim 46, wherein said distributing device is a television receiver.

48. The system of claim 40, wherein said transmitting device is a media twist line.

49. The system of claim 48, wherein said distributing device is a television receiver.

50. The system of claim 40, wherein said standard twisted pair wire is a copper wire.

51. The system of claim 40, wherein said standard twisted pair wire is a category five wire.

52. The system of claim 40, wherein said standard twisted pair wire is a media twist line.

53. A system for distributing an event to a viewer, comprising:
a capturing device for capturing said event as a broadcast transmission, said broadcast transmission having at least a frequency of 4.5 megahertz;
a transmitting device for transmitting said broadcast transmission to a distributing device; and
a modulator/demodulator device between said distributing device and said viewer for distributing said broadcast transmission from said distributing device to said viewer over a standard twisted pair wire at said at least a frequency of 4.5 megahertz.

54. The system of claim 53, wherein said capturing device is a broadcast quality camera.

55. The system of claim 53, wherein said broadcast transmission has greater than 4.5 megahertz frequency.

56. The system of claim 53, wherein said broadcast transmission has a 4.5 megahertz frequency.

57. The system of claim 53, wherein said transmitting device is a satellite transmitter.

58. The system of claim 57, wherein said distributing device is a satellite receiver.

59. The system of claim 53, wherein said transmitting device is a cable line.

60. The system of claim 59, wherein said distributing device is a television receiver.

61. The system of claim 53, wherein said transmitting device is a media twist line.

62. The system of claim 61, wherein said distributing device is a television receiver.

63. The system of claim 53, wherein said standard twisted pair wire is a copper wire.

64. The system of claim 53, wherein said standard twisted pair wire is a category five wire.

65. The system of claim 53, wherein said standard twisted pair wire is a media twist line.

66. A system for distributing a stereophonic event to a listener, comprising:
a capturing device for capturing said stereophonic event as a stereophonic transmission;
a transmitting device for transmitting said stereophonic transmission to a distributing device; and
a modulator/demodulator device between said distributing device and said listener for distributing said stereophonic transmission from said distributing device to said listener over a standard twisted pair wire.

67. The system of claim 66, wherein said capturing device is a broadcast quality camera.

68. The system of claim 66, wherein said transmitting device is a satellite transmitter.

69. The system of claim 68, wherein said distributing device is a satellite receiver.

70. The system of claim 66, wherein said transmitting device is a cable line.

71. The system of claim 70, wherein said distributing device is a television receiver.

72. The system of claim 66, wherein said transmitting device is a media twist line.

73. The system of claim 72, wherein said distributing device is a television receiver.

74. The system of claim 66, wherein said standard twisted pair wire is a copper wire.

75. The system of claim 66, wherein said standard twisted pair wire is a category five wire.

76. The system of claim 66, wherein said standard twisted pair wire is a media twist line.
